(19) United States
(12) Patent Application Publication
(10) Pub. No.: US 2018/0349356 A1
(43) Pub. Date: Dec. 6, 2018

(54) STANDARD SIGNAL CONVERSION METHOD AND DEVICE

(71) Applicant: Wen-Hsien KAO, Luodong Township (TW)

(72) Inventor: Wen-Hsien KAO, Luodong Township (TW)

(21) Appl. No.: 15/993,975

(22) Filed: May 31, 2018

(30) Foreign Application Priority Data
May 31, 2017 (TW) 106118169

(51) Int. Cl. G06F 17/27; G06F 17/30; G06F 21/45

(52) U.S. Cl. CPC G06F 17/2785; G06F 21/45; G06F 17/30569

(57) ABSTRACT

A standard signal conversion method and device, providing a standard signal conversion database, the existing electronic machine device of access matching function converts the signal into at least two different types of signal correctly, wherein various types of signal can be converted arbitrarily, and inversely converted into the original signal without errors, avoiding the reciprocating conversion of the signal resulting in defect errors, to secure the password or convert the signal type.

to

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF INVENTION

### 1. Field of the Invention

The present invention relates generally to a standard signal conversion method and device, converting one input signal into other different types of standard signal, different types of signals can be converted arbitrarily, and inversely converted into the original signal without errors.

### 2. Description of Related Art

At present, the known Email and various website platforms logged in by using account number and password, including operation, control, transmission and translation activities, requiring entering security password or converting signal type are very popular and diversified. Simple passwords cannot prevent hacking and complicated and numerous passwords are likely to result in mistakes, the letter signal may be directly converted into improper or wrong letter signal. Thus, the subsequent security password, operation, control, transmission and translation activities may result in misoperation or error messages.

### BRIEF SUMMARY OF THE INVENTION

In order to solve the above problem, the present invention provides an unprecedented standard signal conversion method and device. The security password or converted signal is complicated and diversified by signal conversion method, and the conversion is accurate and free from errors, so the present invention is described below.

The present invention is a standard signal conversion method, using the standard signal conversion database to convert signals. The standard signal conversion database uses different countries' languages as different types of standard signal, and multiple different types of standard signal are grouped into standard signal set, and the standard signal set does not limit the group count, any type of the different types of standard signal in any group of the standard signal set is single number, and the different types of single standard signal are relatively convertible signal in the groups of the same standard signal set, characterized by using said standard signal conversion database.

In an embodiment of said standard signal set, different types of standard signal in the same group of the standard signal set may use the same semantic words in different countries' languages.

In an embodiment of standard signal, the different types of standard signal use any one of language, character, number, color, symbol, sound, pattern and image.

The standard signal may he provided with peer-to-peer search target codes.

In an embodiment, the standard signal conversion database contains the standard signal to be converted matched by accessing, non-specified standard signal will not be converted.

The present invention is also standard signal conversion device wherein the electronic machine device uses any standard signal conversion method mentioned above. The electronic machine device may contain a transmission equipment. The electronic machine device may contain any one of various exchange and computing platforms in the network. The electronic machine device may contain any one of communication device, telecom machine room, network Cloud and wireless transmission.

### BRIEF DESCRIPTION OF THE DRAWINGS

FIG. 1 is the schematic diagram of implementation steps of this method

FIG. 2 is the schematic diagram of standard signal conversion database of the present invention

### DETAILED DESCRIPTION OF THE INVENTION

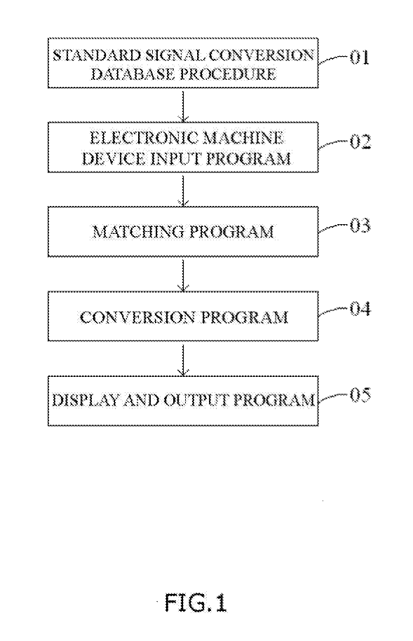

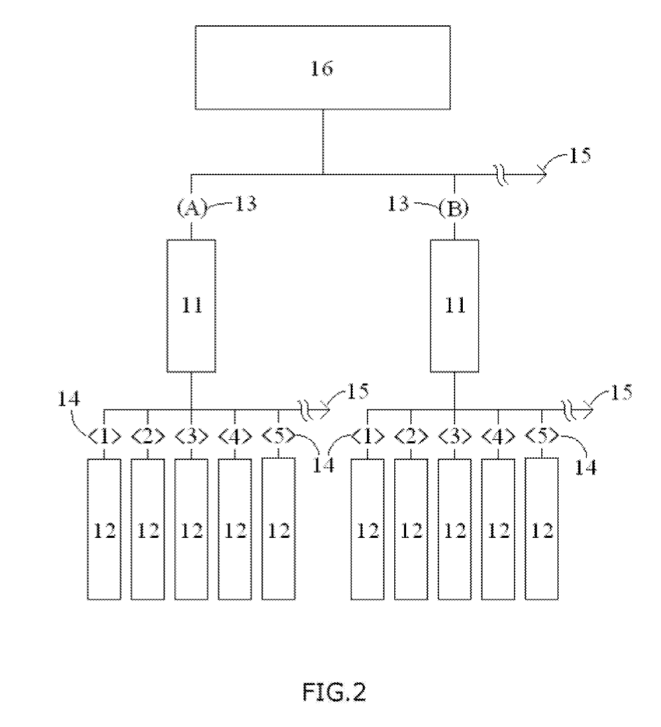

For further description of the method and device implementation method of the present invention, referring to FIGS. 1 and 2. For convenient illustration of the implementation of the present invention, the interface and code sides are not involved for the moment, the simple character symbol method is used only. In one of the embodiments of the present invention, the standard signal conversion database procedure 01 is executed to establish a standard signal conversion database 16. The database has at least one standard signal set 11, and the any standard signal set 11 comprises at least two different types of signal. Different types of signal can be classified by using the words in different countries' languages. For convenient use, various types of signal in the group of each standard signal set 11 are classified as the same standard signal set 11 by the same semantic words in different languages. For example, the standard signal conversion database 16 is provided with standard signal set 11, simply compiled as follows for convenient description of implementation method:

A {1( [symbol] )\2(A standard signal)\3(Un signal standard)\4( [symbol] [symbol] [symbol] )\5(Ein Standardsignal)\6( [symbol] )\7(Un segnale standard)\8(Evα πρóτνπo σημα)\9(A vexillum)\10(123.$ 6)\ . . . }

B {1( [symbol] )\2(Electronic code)\3(code électronique)\4( [symbol] [symbol] [symbol] )\5(elektronischer Code)\6( [symbol] )\7(codice elettronico)\8(Hλεκτρoνικóζ κωôικóζ)\9(electronic codice)\10(1*-&#.6)\ . . . }

Said groups wherein the symbol represents the group of standard signal set 11, the letter before symbol { } represents the group code 13. For example, A { } represents the group code 13 of Group A standard signal set 11, B { } represents the group code 13 of Group B standard signal set 11, and so forth. The standard signal set 11 is unlimited number 15, the symbols ( ) in the symbol { } represent various types of signal. The text in the symbol ( ) is the standard signal 12 in the present invention. The number before the symbol ( ) represents the type code 14 of each standard signal 12, different types of standard signal 12 are separated by slash \, e.g. A{1( )\2( )\3( ) . . . }, wherein the numbers 1, 2 and 3 before each symbol ( ) represent the type code 14 of Types 1, 2 and 3 standard signal 12 of Group A standard signal set 11 respectively, by analogy. The type code 14 of the any standard signal 12 is combined with the group code 13 of the standard signal set 11 to obtain the code of the standard signal 12, the standard signal 12 type of any standard signal set 11 is unlimited number 15. A {1( [symbol] )\2(A standard signal)\3(Un signal standard)\ . . . }, wherein the words “ [symbol] ”, “A standard signal”, “Un signal standard” in symbols ( ) of Types 1, 2 and 3 are the standard signal 12 in the present invention. Various types of standard signal 12 are in the group of the standard signal set 11, any type of standard signal 12 in the group is single number, and the any type of standard signal 12 in the group is relatively converted signal, and the any standard signal 12 text and the code are peer-to-peer search target to each other, e.g. “A1”=“ [symbol] ”, “A2”=“A standard signal”, “A3”=“Un signal standard” . . . , by analogy. A program database for read matching is established by said method, this is the standard signal conversion database 16 of the present invention. Based on the existing electronic machine device, as long as the input, read matching, conversion, output or access operation is executed in general way, the demonic machine device input program 02, matching program 03, conversion program 04, display and output program 05 can be executed directly. For example, the security password is required tier login, the text or code of any standard signal 12 is used, when the “ [symbol] ” or code “B1” is used, the electronic machine device input program 02 is executed, the matching program 03 is entered through the standard signal conversion database 16 of the present invention immediately, the input signal must match the compiled standard signal 12 characters or code. The two input signals can enter the Type 1 standard signal 12 of Group B standard signal set 11. Any type of standard signal 12 in the Group B is relatively converted signal. Thus, the text of any type of standard signal 12 coded B1, B2, . . . Bn in the Group B standard signal set 11 can be obtained by conversion through conversion program 04 and display and output program 05 as the login password, and the original text remains when the original type code B1 is converted. Afterwards, simple code is used for search access, to change the login password, the type is changed in the group or another group is operated in the same way. For example, when any code input of “ [symbol] ” or A1, A2, . . . An is used, the text of any type of standard signal 12 in Group A standard signal set 11 can be obtained as login password.

The standard signal conversion database 16 established by said editing mode, any standard signal 12 conversion is relatively each type of single signal, the input signal is the text in the standard signal 12 matched, this signal can be converted into different types of text arbitrarily among various types, and inversely converted into the original signal without errors. The literal type is taken as converted signal, but differing from the orientation of general translation software type, arbitrary letter signal is entered, the software paraphrases the words and sentences automatically and searches for the target language in database for direct conversion, and the signal has applicable grammar problem, so that there may be multiple letter signals after conversion. It is favorable for translation, but the conversion accuracy and signal reliability are insufficient. For example, a phrase is imported into general translation software, converted into different languages by reciprocating translation, different results will occur after translation, and which are difficult to be translated into the original phrase, proving the letter signal conversion error. To prevent errors, the standard signal conversion database 16 of the present invention requires the input signal to match the standard signal 12 or code before one-to-one conversion. Arbitrary input signal is unlikely to meet the matching condition, failing operation, but this limitation can prevent hacking, operationally simple semantic words and codes are optional, convenient for memory and more options as password or operation, control, transmission and translation. According to said differences, the standard signal conversion database 16 conversion mode of the present invention can avoid the signal conversion defects, and can use simple codes. Therefore, the standard signal 12 converted by this method can provide complex and numerous account numbers and passwords correctly, and the security password can be changed at any time.

Said embodiment 1 only describes the security password operation mode, even if the semantic words are converted simply, they must match the standard signal 12 or code before one-to-one conversion. There are no problems of automatic paraphrasing of words and sentences by software program and applicable grammar. Therefore, any one of language, character, number, color, symbol, sound, pattern and image types can be used or changed irregularly to establish the standard signal 12 of each standard signal set 11 as required in practice. For example, the codes A10 and B10 of standard signal set 11 as mentioned earlier, the characters are changed to A10(123$̂6) and B10(12-&#.6), the two standard signals 12 are added to character list, or a type is complicated by lengthening the string, only simple text or code is memorized. Thus, said standard signal conversion database 16 can provide the security password or converted signal with unprecedented anti-hacking essentials, including secrecy, operation, control, transmission and translation, various sophisticated signals can be converted conveniently and correctly.

Said embodiment describes the implementation method for the method and device of the present invention, not for limiting the method and device of the present invention.

1. A standard signal conversion method, a standard signal conversion database is established, different signals are converted and exported by read matching of electronic machine device; the standard signal conversion database comprises at least one standard signal set, any standard signal set is formed of more than two different types of standard signal, different types of standard signal in any standard signal set are single number, various types of standard signal in any standard signal set are relatively converted signals to each other, and the input signal must match the standard signal in standard signal conversion database before one-to-one conversion; it is characterized by that the standard signal conversion database in said editing mode is used as electronic machine device to convert different signals to provide or transmit translated signal and security password.

2. The method defined in claim 1, wherein said standard signal set, different types of standard signal in the same group of the standard signal set use the same semantic language or words of different countries.

3. The method defined in claim 1, wherein said standard signal the different types of standard signal use any one of language, text, number, color, symbol, sound, pattern and image.

4. The method defined in claim 1, wherein said standard signal is provided with searchable and peer-to-peer converted codes.

5. The method defined in claim 1, wherein said standard signal conversion database in matching input signal, the standard signal not matching the standard signal conversion database disallows conversion.

6. A standard signal conversion method has the following steps:
standard signal conversion database procedure, a standard signal conversion database is established as the program database of electronic machine device to convert and export different signals; the standard signal conversion database has at least one standard signal set, and any standard signal set is formed of more than two different types of standard signal, and each type of standard signal in any standard signal set is single number, and various types of standard signal in any standard signal set are relatively converted signals to each other, and any standard signal is provided with searchable and peer-to-peer convertible group type code;
electronic machine device input program, the electronic machine device enters the signal to be converted or searchable group type code;
matching program, the electronic machine device input program received signal or searchable group type code is used as condition, the standard signal or group type code matching the condition is searched in standard signal conversion database;
conversion program, the standard signal or group type code matching the condition is found out by matching program, the standard signal or group type code is converted into the required type standard signal established in standard signal conversion database;
display and output program, connected to the display equipment, displaying the converted standard signal of required type and providing output.

7. The method defined in claim 6, wherein said standard signal set, different types of standard signal in the same group of the standard signal set use the same semantic language or words of different countries.

8. The method defined in claim 6, wherein said standard signal the different types of standard signal use any one of language, text, number, color, symbol, sound, pattern and image.

9. The method defined in claim 6, wherein the display equipment of display and output program is provided with a transmission equipment.

10. The method defined in claim 6, wherein said standard signal conversion database in matching input signal, the standard signal or group type code not matching the standard signal conversion database disallows conversion.
